(19) United States
(12) Patent Application Publication
(10) Pub. No.: US 2013/0143657 A1
(43) Pub. Date: Jun. 6, 2013

(54) Input Mapping Regions

(71) Applicant: Adam J. Overton, Redmond, WA (US)

(72) Inventor: Adam J. Overton, Redmond, WA (US)

(73) Assignee: AMAZON TECHNOLOGIES, INC., Reno, NV (US)

(21) Appl. No.: 13/295,133

(22) Filed: Nov. 14, 2011

(51) Int. Cl. A63F 13/06; G09G 5/00; G06F 3/041

(52) U.S. Cl. 463/37; 345/173; 345/684

(57) ABSTRACT

Disclosed are various embodiments for implementing various forms of user actions on a touch sensitive device. A touch input generated on a touch screen display device is converted into a graphical user interface event. One or more touch input events are provided to the media application based at least in part on input from one or more clients. The touch input received from the client is mapped to a corresponding user action. The media application performs the user action, obtains the output data and sends the application stream to each of the clients.

### BACKGROUND

Interaction with a browser or mobile application user interface may involve input using a variety of input devices such as, for example, a keyboard, a mouse, a trackball, a joystick, a touch screen, or other input device. Input mechanisms vary in the number and types of events that are capable of being transmitted. In addition, the range of available input devices is expanding as technology advances.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 is a drawing of a networked environment according to various embodiments of the present disclosure.

FIG. 2 is a drawing of an example of a user interface rendered by a client in the networked environment of FIG. 1 according to various embodiments of the present disclosure.

FIG. 3 is a flowchart illustrating one example of functionality implemented as portions of an input mapping application executed in a computing device in the networked environment of FIG. 1 according to various embodiments of the present disclosure.

FIG. 4 is a schematic block diagram that provides one example illustration of a computing device employed in the networked environment of FIG. 1 according to various embodiments of the present disclosure.

### DETAILED DESCRIPTION

The present disclosure relates to implementing a variety of user actions on a touch sensitive client device for media applications. Various embodiments of the present disclosure facilitate translation of touch events received from a touch sensitive client device into corresponding inputs recognizable by a media application. For example, in some embodiments, a media application may be executed by a computing device such as a server. The media application generates a video transmission that is ultimately rendered in the form of a user interface on a touch sensitive client device. Input from the client device may be received by an input mapping application over a network and subsequently translated as a corresponding input recognized by the media application. The media application performs the appropriate user action and responds with appropriate changes in output to the video transmission that is transmitted to the touch sensitive client device over a network. In the following discussion, a general description of the system and its components is provided, followed by a discussion of the operation of the same.

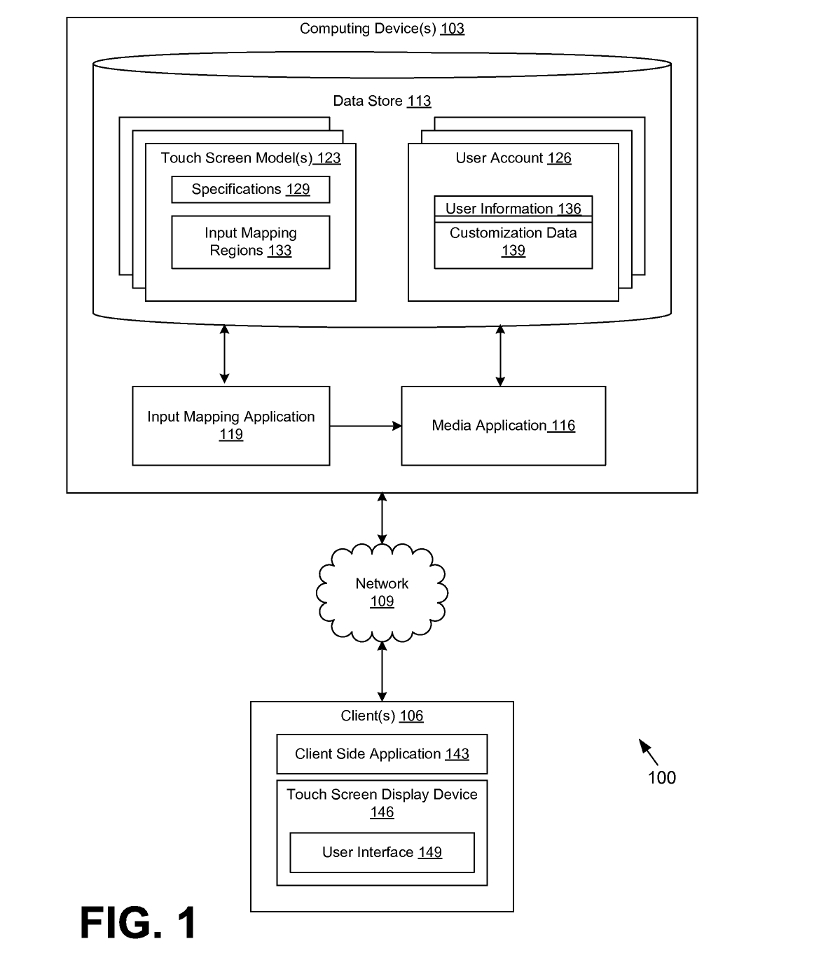

With reference to FIG. 1, shown is a networked environment 100 according to various embodiments. The networked environment 100 includes a computing device 103, one or more client devices 106, and a network 109. The network 109 includes, for example, the Internet, intranets, extranets, wide area networks (WANs), local area networks (LANs), wired networks, wireless networks, or other suitable networks, etc., or any combination of two or more such networks.

The computing device 103 may comprise, for example, a server computer or any other system providing computing capability. Alternatively, a plurality of computing devices 103 may be employed that are arranged, for example, in one or more server banks or computer banks or other arrangements. For example, a plurality of computing devices 103 together may comprise a cloud computing resource, a grid computing resource, and/or any other distributed computing arrangement. Such computing devices 103 may be located in a single installation or may be distributed among many different geographical locations. For purposes of convenience, the computing device 103 is referred to herein in the singular. Even though the computing device is referred to in the singular, it is understood that a plurality of computing devices 103 may be employed in the various arrangements as described above.

Various applications and/or other functionality may be executed in the computing device 103 according to various embodiments. Also, various data is stored in a data store 113 that is accessible to the computing device 103. The data store 113 may be representative of a plurality of data stores 113 as can be appreciated. The data stored in the data store 113, for example, is associated with the operation of the various applications and/or functional entities described below.

The components executed on the computing device 103, for example, include a media application 116, an input mapping application 119, and other applications, services, processes, systems, engines, or functionality not discussed in detail herein. The media application 116 is executed to serve up or stream video and/or other media generated by an application to the client 106 that may comprise, for example, a touch screen display device 146. To this end, the media application 116 may generate various streaming or otherwise transmitted content such as, for example, games, simulations, maps, movies, videos, and/or other multimedia files.

The media application 116 may communicate with the client 106 over various protocols such as, for example, hypertext transfer protocol (HTTP), simple object access protocol (SOAP), real-time transport protocol (RTP), real time streaming protocol (RTSP), real time messaging protocol (RTMP), user datagram protocol (UDP), transmission control protocol (TCP), and/or other protocols for communicating data over the network 109. The input mapping application 119 is executed to facilitate receipt of various user inputs from the client 106 that include, for example, hovering, selecting, scrolling, zooming, and/or other operations.

The data stored in the data store 113 includes, for example, touch screen model(s) 123, user account(s) 126, and potentially other data. Each of the touch screen model(s) 123 includes various data associated with a corresponding mobile device including, for example, specifications 129, input mapping regions 133 and/or other information. In addition, specifications 129 associated with each of the touch screen model(s) 123 may include various data including dimensions, size, structure, shape, response time, and/or other data. Input mapping regions 133 are areas are defined in a touch screen display device 146 to which specific functions in the media application 116 are assigned. Touch events occurring in such areas are ultimately translated into corresponding inputs recognized by the media application 116. Touch events represent points of contact with the touch screen display device 146 and changes of those points with respect to the touch screen display device 146. Touch events may include, for example, tap events, and drag events, pinch events, mouse up events, mouse down events, mouse move events, and/or other points of contact with the touch screen display device 146. Inputs recognized by the media application 116 may comprise, for example, scroll commands, hover commands, zoom commands or other commands as will be described.

Each user account 126 includes various data associated with a user that employs client 106 to interact with media application 116. Each user account 126 may include user information 136 such as, usernames, passwords, security credentials, authorized applications, and/or other data. Customization data 139 includes settings made by a user employing a client 106 that specify a user customization or alternations of default versions of the input mapping regions 133. Additionally, customization data 139 may include other various aspects of the user's viewing environment. When a user employing a client 106 customizes the input mapping regions 133, the computing device 103 maintains customization data 139 that defines customized versions of the input mapping regions 133 in the data store 113 for use in interacting with media application 116 as rendered on the client 106. The customization data 139 may correspond to data associated with the input mapping regions 133 saved normally by the media application 116 or may correspond to a memory image of the media application 116 that may be resumed at any time.

The client 106 is representative of a plurality of client devices that may be coupled to the network 109. The client 106 may comprise, for example, a processor-based system such as a computer system. Such a computer system may be embodied in the form of a desktop computer, a laptop computer, a personal digital assistant, a cellular telephone, music players, web pads, tablet computer systems, game consoles, touch screen monitors, tablet computers, smartphones, or other devices with like capability.

The client 106 may include a touch screen display device 146 and may include one or more other input devices. Such input devices may comprise, for example, devices such as keyboards, mice, joysticks, accelerometers, light guns, game controllers, touch pads, touch sticks, push buttons, optical sensors, microphones, webcams, and/or any other devices that can provide user input.

The client 106 may be configured to execute various applications such as a client side application 143 and/or other applications. The client side application 143 is executed to allow a user to launch, play, and otherwise interact with a media application 116 executed in the computing device 103. To this end, the client side application 143 is configured to receive input provided by the user through a touch screen display device 146 and/or other input devices and send this input over the network 109 to the computing device 103 as input data. The client side application 143 is also configured to obtain output video, audio, and/or other data over the network 109 from the computing device 103 and render a view of the media application 116 on the touch screen display device 146. To this end, the client side application 143 may include one or more video and audio players to play out a media stream generated media application 116. In one embodiment, the client side application 143 comprises a plug-in within a browser application. The client side application 143 may be executed in a client 106, for example, to access and render network pages, such as web pages, or other network content served up by the computing device 103 and/or other servers. To this end, the client side application 143 renders streamed or otherwise transmitted content in the form of a user interface 149 on a touch screen display device 146. The client 106 may be configured to execute applications beyond client side application 143 such as, for example, browser applications, email applications, instant message applications, and/or other applications.

Next, a general description of the operation of the various components of the networked environment 100 is provided. To begin, a user at a client 106 sends a request to a computing device 103 to launch a media application 116. The computing device 103 executes media application 116 in response to the appropriate user input. On first access, the media application 116 may query the client 106 in order to determine the type of touch screen model 123 of the client 106. In one embodiment, as an initial setting, the media application 116 may determine, based on the type of touch screen model 123, the input mapping regions 133 that are to be used for various input at the client 106. In another embodiment, as an initial setting, the media application 116 may determine, based on the type of media application 116, the input mapping regions 133 that are to be used for various input at the client 106. Input mapping regions 133 may vary based on different types of applications, classes of applications, different types of clients, different classes of clients and/or other considerations.

Additionally, the media application 116 may facilitate the creation of a user account 126 by providing one or more user interfaces 149 for establishing the user account 126 if the user account 126 has not already been established. For instance, the media application 116 may prompt the user to indicate a name for the user account 126, a password for the user account 126, and/or any other parameter or user information 136 for establishing the user account 126. In another embodiment, the media application 116 facilitates specification of customization data 139 associated with input mapping regions 133 if a user employing a client 106 wishes to customize the input mapping regions 133. As a result, the media application 116 may adjust an area of one or more of the input mapping regions 133 based on such customization, where such changes are stored as the customization data 139.

In one embodiment, a user employing a client 106 touches the touch screen display device 146 using a finger, stylus, and/or other device. A coordinate input corresponding to the touch event is generated by the client side application 143 and sent to the input mapping application 119. The input mapping application 119 determines if the touch event occurred within one of the input mapping regions 133. When the input mapping application 119 determines that the touch event occurred within one of the input mapping regions 133, the input mapping application 119 translates the touch event received in client side application 149 into a corresponding input that is recognizable by the media application such as, for example, hovering, selecting, scrolling, zooming and/or other actions. The input mapping application 119 then sends the corresponding input to media application 116.

The media application 116 performs the appropriate user action and modifies the graphical output in the video transmission. The media application 119 continually transmits the video transmission to the client side application 143 over the network 109 as the output data. Ultimately, the effect of the touch event performed by the user of the client 106 may be reflected in the client side application 143 as a corresponding user action such as, for example, hovering, selecting, scrolling, zooming, and/or other actions. Further, touch events generated at a client 106 may be mapped as other types of inputs generated by another type of input device. For example, a pinch gesture corresponding to two fingers moving together on a touchscreen, used to enable zooming may be translated as a scroll wheel zoom action recognized by the media application 116.

As a non-limiting example, when a touch event is received in one of the input mapping regions 133 correlated with a scrolling action, the input mapping application 119 maps the touch event to a scrolling input and sends the scroll input to media application 116. Media application 116 scrolls a view of the video transmission in a predefined direction associated with the respective input mapping region 133. The scrolling video transmission is transmitted by the media application 116 to the client 106 over the network 109 as the output data. The client side application 143 obtains the output data and renders a view of the scrolling video transmission on the touch screen display device 146.

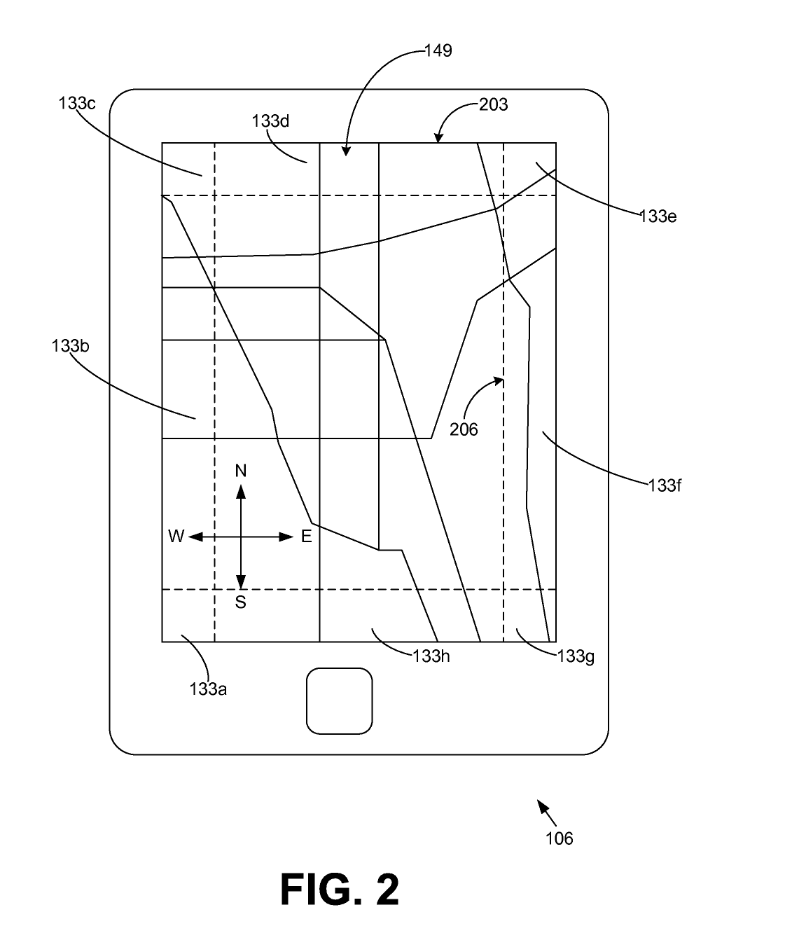

Referring next to FIG. 2, shown is one example of a client 106 upon which is rendered a user interface 149 by a client side application 143 (FIG. 1). The user interface 149 is rendered on the touch screen display device 146 of the client 106 in the networked environment 100 (FIG. 1). Specifically, FIG. 2 depicts one example of a video transmission embodying a user interface 149 depicted as a map that is generated by a media application 116 (FIG. 1), and encoded into a video transmission, sent over the network 109 (FIG. 1), and rendered for display by the client side application 143 on the touch screen display device 146.

Although the example of a map used in FIG. 2, it is understood that other types of user interfaces 149 may be employed in the embodiments of the present disclosure. The layout of the various elements in the user interface 149 as show in FIG. 2 is provided merely as an example, and it not intended to be limiting. Other types of user interfaces 149 may be employed, such as, for example, games, simulations, document viewers, movies, videos, and/or other types of user interfaces 149. As shown, the view depicts the user interface 149, a plurality of input mapping regions 133, the outer border 203 of the input mapping regions 133, and the inner border 206 of the input mapping regions 133.

The input mapping regions 133 are correlated to a coordinate plane of the touch screen display device 146. The input mapping regions 133 may include, button activation regions, selecting regions, scrolling regions, and/or other regions that are associated with one or more user actions. In one embodiment, each of the input mapping regions 133 has an outer border 203 that is aligned with an edge of the viewing area of the touch screen display device 146, where such input mapping regions 133 are used to generate a scrolling input. In one embodiment, a speed of the scroll action is determined to be proportional to a distance between the outer border 203 and the coordinate input of a touch event relative to the total distance between the outer border 203 and the inner border 206 of the respective one of the input mapping regions 133. In another embodiment, the speed of the scroll action is determined to be proportional to the distance between the inner border 206 and the coordinate input of a touch event relative to the total distance between the outer border 203 and the inner border 206 of the respective one of the input mapping regions 133.

The graphical components, such as input mapping regions 133, comprising information shown in FIG. 2 are merely examples of various types of features that may be used to accomplish the specific function noted. Because the client 106) is decoupled from the hardware requirements of media application 116, the media application 116 may be used by variety of clients 106 (that are capable of transmitting video with acceptable bandwidth and latency over a network 109). The view is rendered on touch screen display device 146 associated with client 106, according to various embodiments of the present disclosure.

In another embodiment, FIG. 2 may be viewed as depicting the display output of client side application 143, according to various embodiments of the present disclosure. The media application 116 generates the video transmission and sends the video transmission to a client 106 for display in the viewing area of a touch screen display device 146 over a network 109. To illustrate, a user a client 106 launches a media application 116 such as StarCraft II, a military science fiction real-time strategy video game, developed and released by Blizzard Entertainment and released on Jul. 27, 2010. A user employing a client 106 may initiate a scrolling action when coordinates associated with a touch event are positioned in one of a plurality of input mapping regions 133.

Accordingly, the StarCraft II media application 116 may expect input from a mouse scroll wheel, input from dragging a scroll bar, input from keyboard arrow keys and/or other scroll input devices. Various embodiments of the present disclosure enable the input mapping application 119 to map the touch event to an appropriate input such as, a scroll input that is recognizable by the media application 116 and sends such input to the StarCraft II media application 116. The StarCraft II media application 116 scrolls a view of the video transmission or takes other appropriate action in accordance with the input. In the case of scrolling, the scrolling direction may be the same as that of the location of the respective input mapping region 133. However, it is noted that scrolling in some clients 106 may happen in a direction opposite the location of the respective input mapping region 133. The viewing area of the touch screen display device 146 may also include various user interface components for controlling the media application 116, exiting the media application 116, communicating with other users, controlling the audio, and/or other components.

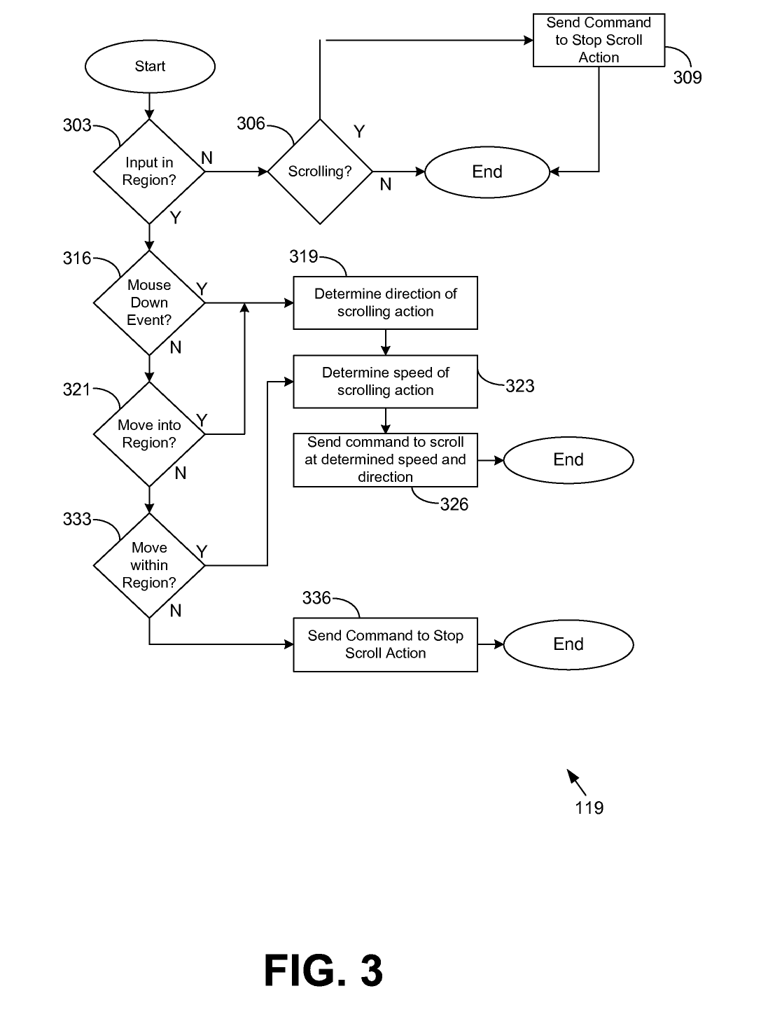

Referring next to FIG. 3, shown is a flowchart that provides one example of the operation of a portion of the input mapping application 119 (FIG. 1) according to various embodiments. It is understood that the flowchart of FIG. 3 provides merely an example of the many different types of functional arrangements that may be employed to implement the operation of the input mapping application 119 as described herein. As an alternative, the flowchart of FIG. 3 may be viewed as depicting an example of steps of a method implemented in the computing device 103 (FIG. 1) according to one or more embodiments.

The flowchart sets forth an example of the functionality of the input mapping application 119 in translating touch events, combinations of touch events, and/or other touch gestures from the client 106 that specifically involve scrolling While scrolling is discussed, it is understood that this is merely an example of the many different types of inputs that may be invoked with the use of an input mapping region 133. Specifically, the touch events comprise messages indicating coordinates of a touch or other manipulation of the touch screen display device (FIG. 1). In addition, the flowchart of FIG. 3 provides one example of how the input mapping application 119 processes various mouse events, when at least one coordinate input associated with the mouse event has been received in one of the input mapping regions 133 that translates the mouse event as a corresponding scroll input that is recognized by the media application 116. It is understood that the flow may differ depending on specific circumstances. Also, it is understood that other flows and user actions may be employed other than those described herein.

Beginning with box 303, when a user employing a client 106 (FIG. 1) desires to scroll a view of the video transmission of a media application 116 (FIG. 1) displayed in a viewing area of touch screen display device 146 (FIG. 1), the input mapping application 119 determines whether the coordinate input associated with a mouse event is positioned in one of the plurality of input mapping regions 133 (FIG. 2) that corresponds to a scrolling action. If the coordinate input does correspond to one of the input mapping regions 133, the input mapping application 119 moves to box 316. If the coordinate input does not correspond to one of the input mapping regions 133 that corresponds to a scrolling action, the input mapping application 119 moves to box 306 and determines whether a previously initiated scrolling functions in progress. Assuming no scrolling was previously in progress, the input mapping application 119 ends. If scrolling is in progress, the input mapping application 119 moves to box 309 and sends a command to the media application 116 to stop the previously initiated function. Thereafter, the input mapping application 119 (FIG. 1) ends.

If the coordinate input corresponds to one of the input mapping regions 133 that corresponds to a scrolling action in box 303, the input mapping application 119 moves to box 316 and determines whether the coordinate input is associated with a mouse down event. Assuming the coordinate input does not correspond to a mouse down event, the input mapping application 119 moves to box 321. If the coordinate input is associated with a mouse down event, the input mapping application 119 proceeds to box 319. In box 319, the input mapping application 119 determines the direction of the scroll action based on a predefined direction associated with the respective one of the input mapping regions 133. Such a direction may be vertical, horizontal, diagonal, and/or other directions.

Next, the input mapping application 119 proceeds to box 323 and determines the speed of the scroll action. As an example, the input mapping application 119 (FIG. 1) may determine the speed of the scroll action to be proportional to a distance between the coordinates of a mouse event and the outer border 203 (FIG. 2) relative to the total distance between the outer border 203 and the inner border 206 of the respective input mapping region 133. As another example, the input mapping application 119 (FIG. 1) may determine the speed of the scroll action to be proportional to a distance between the coordinates of the mouse event and the inner border 206 (FIG. 2) relative to the total distance between the outer border 203 and the inner border 206 of the respective input mapping region 133. The input mapping application 119 then proceeds to box 326 in which the input mapping application 119 sends a scroll command to media application 116 to scroll a view at the speed and direction associated with the coordinates of the mouse event. Thereafter, the input mapping application 119 ends.

Assuming that the mouse event is not a mouse down event as determined in box 316, the input mapping application 119 proceeds to box 321. In box 321, the input mapping application 119 determines whether the coordinate input is associated with a drag-action into one of the input mapping regions 133 from a position on the touch screen display device 146 that is located outside of the input mapping regions 133. As an example, a user employing a client 106 may initially provide a touch input to the touch screen display device 146 outside of the input mapping regions 133 (FIG. 2). Then, the user employing a client may drag their finger, stylus, and/or other implement to move into one of the input mapping regions 133. In doing so, the mouse event moves into one of the input mapping regions 133 from another location on the touch screen display device 146. Specifically, mouse location events may be generated periodically during the movement that indicate the location of the mouse at any given time If the mouse event indicates movement into a respective one of the input mapping regions 133, the input mapping application 119 proceeds to box 319 to determine the direction of the scroll action as described above. Thereafter, the input mapping application 119 ends.

If the coordinate input is not associated with a drag-action into one of the input mapping regions 133 as determined by box 321, the input mapping application 119 proceeds to box 333. In box 333, the input mapping application 119 determines if the coordinate input is associated with a drag-action within one of the input mapping regions 133. If the coordinate input is associated with a drag-action within one of the input mapping regions 133, the input mapping application 119 moves to box 323 to determine if a change in scroll speed is necessary as described above. Otherwise, the input mapping application 119 proceeds to box 336 and sends a command to the media application 116 to stop the scroll action. Thereafter, the input mapping application 119 ends.

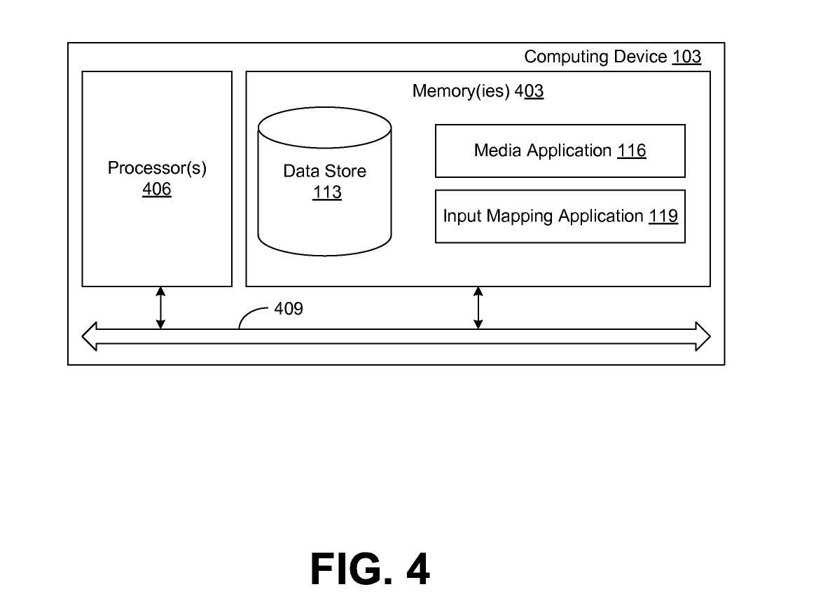

With reference to FIG. 4, shown is a schematic block diagram of the computing device 103 according to an embodiment of the present disclosure. The computing device 103 includes at least one processor circuit, for example, having a processor 406 and a memory 403, both of which are coupled to a local interface 409. To this end, the computing device 103 may comprise, for example, at least one server computer or like device. The local interface 409 may comprise, for example, a data bus with an accompanying address/control bus or other bus structure as can be appreciated.

Stored in the memory 403 are both data and several components that are executable by the processor 406. In particular, stored in the memory 403 and executable by the processor 406 are the media application 116, input mapping application 119 and potentially other applications. Also stored in the memory 403 may be a data store 113 and other data. In addition, an operating system may be stored in the memory 403 and executable by the processor 406.

It is understood that there may be other applications that are stored in the memory 403 and are executable by the processors 406 as can be appreciated. Where any component discussed herein is implemented in the form of software, any one of a number of programming languages may be employed such as, for example, C, C++, C#, Objective C, Java, Javascript, Perl, PHP, Visual Basic, Python, Ruby, Delphi, Flash, or other programming languages.

A number of software components are stored in the memory 403 and are executable by the processor 406. In this respect, the term “executable” means a program file that is in a form that can ultimately be run by the processor 406. Examples of executable programs may be, for example, a compiled program that can be translated into machine code in a format that can be loaded into a random access portion of the memory 403 and run by the processor 406, source code that may be expressed in proper format such as object code that is capable of being loaded into a random access portion of the memory 403 and executed by the processor 406, or source code that may be interpreted by another executable program to generate instructions in a random access portion of the memory 403 to be executed by the processor 406, etc. An executable program may be stored in any portion or component of the memory 403 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 403 is defined herein as including both volatile and nonvolatile memory and data storage components. Volatile components are those that do not retain data values upon loss of power. Nonvolatile components are those that retain data upon a loss of power. Thus, the memory 403 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 406 may represent multiple processors 406 and the memory 403 may represent multiple memories 403 that operate in parallel processing circuits, respectively. In such a case, the local interface 409 may be an appropriate network 109 (FIG. 1) that facilitates communication between any two of the multiple processors 406, between any processor 406 and any of the memories 403, or between any two of the memories 403, etc. The local interface 409 may comprise additional systems designed to coordinate this communication, including, for example, performing load balancing. The processor 406 may be of electrical or of some other available construction.

Although the media application 116, the input mapping application 119, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowchart of FIG. 3 shows the functionality and operation of an implementation of portions of the media application 116 that includes the input mapping application 119. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 406 in a computer system or other system. The machine code may be converted from the source code, etc. If embodied in hardware, each block may represent a circuit or a number of interconnected circuits to implement the specified logical function(s).

Although the flowchart of FIG. 3 shows a specific order of execution, it is understood that the order of execution may differ from that which is depicted. For example, the order of execution of two or more blocks may be scrambled relative to the order shown. Also, two or more blocks shown in succession in FIG. 3 may be executed concurrently or with partial concurrence. Further, in some embodiments, one or more of the blocks shown in FIG. 3 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the media application 116 and the input mapping application 119, that comprises software or code can be embodied in any non-transitory computer-readable medium for use by or in connection with an instruction execution system such as, for example, a processor 406 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1.-3. (canceled)

4. A system, comprising:
at least one computing device; and
an input mapping application executable in the at least one computing device, the input mapping application comprising:
logic that receives at least one set of coordinates that is associated with a coordinate plane that is correlated to a viewing area of a touch screen display device over a network from a client;
logic that determines whether the at least one set of coordinates is positioned within at least one of a plurality of input regions defined in the coordinate plane;
logic that translates the at least one set of coordinates into an input that is recognizable by a media application; and
logic that sends the input to the media application.

5. The system of claim 4, wherein the coordinate plane is two dimensional.

6. The system of claim 4, where the media application generates a video output in the form of a video transmission that is rendered for display in a viewing area of a touch screen display device.

7. The system of claim 6, where a view of the video transmission extends beyond the viewing area of the touch screen display device.

8. The system of claim 7, wherein the media application further comprises logic that encodes the video transmission for rendering in the form of a user interface on the touch screen display device.

9. The system of claim 6, further comprising logic that adjusts an area of each of the input regions relative to the client corresponding to a user input from the client.

10. The system of claim 4, wherein an area of each of the input regions is determined at least in part on a type of media application associated with the video transmission.

11. The system of claim 4, wherein an area of each of the input regions is determined at least in part on a type of client associated with the touch screen display device.

12. The system of claim 4, wherein the input regions are specific to the media application.

13. The system of claim 4, wherein the media application performs at least one media application function in response to the input provided by the input mapping application.

14.-20. (canceled)

21. A non-transitory computer-readable medium embodying a program executable in a computing device, the program comprising:
a media application that generates a video output in the form of a video transmission for rendering on a touch screen client device wherein a display area of the generated video transmission extends beyond a view of the touch screen client device;
code that obtains at least one coordinate input that is associated with a coordinate plane that is correlated to a viewing area of the touch screen client device;
code that determines whether the at least one coordinate input is located within at least one of a plurality of input mapping zones defined in the coordinate plane relative to the touch screen client device;
code that facilitates adjustment of an area of each of the input mapping zones in response to a user input received from a client that embodies the touch screen client device;
code that translates the at least one coordinate input as a corresponding input that is recognizable by the media application;
code that provides the corresponding input to the media application;
code that performs at least one media application function in response to the corresponding input; and
code that sends the video transmission to the client over a network.

22. The non-transitory computer-readable medium of claim 21, further comprising code that initiates rendering of a different portion of the video transmission on the touch screen client device when the at least one media application function corresponds to a scrolling action.

23. The non-transitory computer-readable medium of claim 22, further comprising code that that determines a speed of the scrolling action proportional to a distance between the at least one coordinate input and an edge of at least one of the input mapping zones.

24. A method, comprising the steps of:
generating, in a computing device, a video output in the form of a video transmission of a media application;
receiving, in the computing device, a touch event correlated to a viewing area of a touch screen display device;
determining, in the computing device, whether the touch event is positioned in at least one of a plurality of input regions defined a coordinate plane of the touch screen display device;
translating, in the computing device, the touch event associated with each of the input regions as a corresponding scroll input that is recognizable by the media application;
sending, in the computing device, the scroll input to the media application,
performing, in the computing device, upon receipt of the scroll input a scrolling action that scrolls a view of the video transmission in a predefined direction associated with the at least one of the input regions; and
sending, in the computing device, a rendered version of the video transmission that extends beyond the viewing area of the touch screen display device to the client.

25. The method of claim 24, further comprising the step of altering, in the computing device, an area of each of input regions based at least in part on a user input from a client.

26. The method of claim 24, wherein the predefined direction is selected from the group consisting of a horizontal direction, a vertical direction, and a diagonal direction.

27. The method of claim 24, wherein each of the input regions has an outer border aligned with an edge of the viewing area.

28. The method of claim 24, wherein a speed of the scrolling action is proportional to a distance between the outer border and a location of the touch event.

29. The method of claim 24, wherein each of the input regions has an inner border.

30. The method of claim 24, wherein the speed of the scrolling action is proportional to the distance between the inner border and a location of the touch event.
